(19) United States
(12) Patent Application Publication
(10) Pub. No.: US 2025/0275518 A1
(43) Pub. Date: Sep. 4, 2025

(54) CANINE HEARING PROTECTION SYSTEM

(71) Applicant: Spear Labs, LLC, Charlotte, TN (US)

(72) Inventors: Phillip Dale Lott, Charlotte, TN (US); Darshan Kirit Vyas, Tipp City, OH (US)

(21) Appl. No.: 19/068,276

(22) Filed: Mar. 3, 2025

Related U.S. Application Data
(60) Provisional application No. 63/560,864, filed on Mar. 4, 2024.

(51) Int. Cl. A01K 13/00

(52) U.S. Cl. CPC A01K 13/006

(57) ABSTRACT

A hearing protection system for canines may have a rigid housing and a sleeve surrounding the rigid housing that is configured to be securely placed within an ear canal of a canine. The rigid housing may be structurally configured to continuously extend beyond a Noxon's ridge of the canine. The sleeve may have a tip portion and a top portion. The rigid housing may have a tactile portion extending from the rigid housing with an off-center position relative to the sleeve. The sleeve may have one or more retention portions.

### CROSS-REFERENCE TO RELATED APPLICATIONS

The present application is a conversion of U.S. Provisional Application having U.S. Ser. No. 63/560,864, filed Mar. 4, 2024, which claims the benefit under 35 U.S.C. 119 (e). The disclosure of which is hereby expressly incorporated herein by reference.

### TECHNICAL FIELD

The present disclosure is directed to hearing protection and, more particularly, to insertable ear plugs that stay in a canine's ear during activity and provide comfort while proximal Noxon's ridge.

### BACKGROUND

While a dog's hearing may provide safety and awareness, some instances call for abatement of a dog's hearing. For instance, instances where sudden, loud noises occur may disorient and/or confuse a dog. Another example involves changes in pressure that may damage, or impair, the operation of a dog's hearing. Other instances may intentionally reduce a dog's hearing to prevent distraction or miscommunication. Yet other uses of hearing protection may provide secure physical placement of a speaker in the ear of a dog to increase the efficiency of spoken commands.

With the various uses of hearing protection for dogs, conventional manners of protecting canine hearing involve cover an ear to reduce the volume and/or intensity of sound from entering the ear canal. However, such components that rest on the external portion of a dog's skull are often bulky and unsecure, which may lead to unreliable hearing protection. Accordingly, there is a continued goal to provide hearing protection for dogs that is both more secure and more comfortable than conventional ear coverings.

### SUMMARY

In accordance with various aspects of the disclosure, a canine hearing protection system has a rigid housing and a sleeve surrounding the rigid housing that is configured to be securely placed within an ear canal of a canine. The rigid housing is structurally configured to continuously extend beyond a Noxon's ridge of the canine. The sleeve has a tip portion and a top portion. The rigid housing has a tactile portion extending from the rigid housing with an off-center position relative to the sleeve. The sleeve may have one or more retention portions.

### BRIEF DESCRIPTION OF THE DRAWINGS

Further advantages and features of the present disclosure will become apparent from the following description and the accompanying drawings, to which reference is made.

FIG. 1 is a front elevation view of a part of a canine in which assorted embodiments of a canine hearing protection system can be practiced.

FIG. 2 is a line representation of portions of the canine environment of FIG. 1 where embodiments of this disclosure may be employed.

FIG. 3 is a line representation of portions of the canine environment of FIGS. 1 and 2 utilized in accordance with various embodiments of this disclosure.

FIGS. 4-11 respectively illustrate aspects of a canine hearing protection system structurally configured in accordance with various embodiments of this disclosure.

FIGS. 12-17 respectively illustrate portions of a canine hearing protection system arranged in accordance with assorted embodiments of this disclosure.

FIGS. 18 and 19 respectively illustrate an example pneumatic portion of an ear device that can be utilized in a hearing protection system in some embodiments.

FIGS. 20-23 respectively illustrate aspects of a canine hearing protection system constructed in accordance with some embodiments of this disclosure and shown.

FIGS. 24 and 25 respectively illustrate portions of a canine hearing protection system arranged in accordance with assorted embodiments of this disclosure and shown in use with a canine.

FIG. 26 charts operational data for various embodiments of an ear device utilized as part of a hearing protection system in accordance with various embodiments.

### DETAILED DESCRIPTION

Embodiments provide an ear plug system that fits in the ear canal of a canine to provide hearing protection while being physically secure proximal Noxon's ridge.

Reference will now be made in detail to presently preferred embodiments and methods of the present disclosure, which constitute the best modes of practicing the present disclosure presently known to the inventors. However, it is to be understood that the disclosed embodiments are merely exemplary of the present disclosure that may be embodied in various and alternative forms. Therefore, specific details disclosed herein are not to be interpreted as limiting, but merely as a representative basis for any aspect of the present disclosure and/or as a representative basis for teaching one skilled in the art to variously employ the present disclosure.

It is also to be understood that this present disclosure is not limited to the specific embodiments and methods described below, as specific components and/or conditions may, of course, vary. Furthermore, the terminology used herein is used only for the purpose of describing particular embodiments of the present disclosure and is not intended to be limiting in any way.

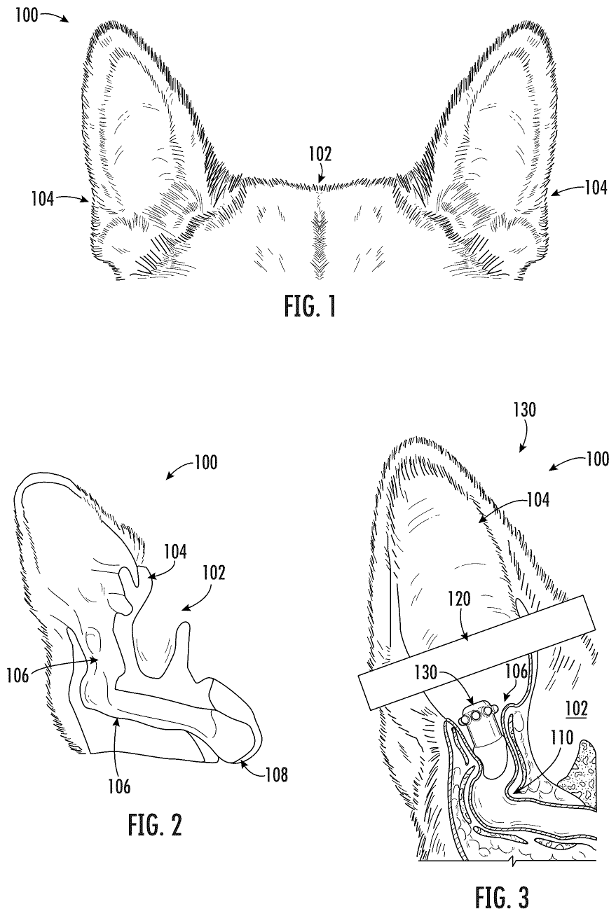

Turning to the drawings, FIGS. 1-3 generally illustrate portions of a canine environment 100 in which aspects of a hearing protection system may be operated. FIG. 1 is a line representation of aspects of a canine skull 102 that presents a pair of ears 104. It is noted that the skull 102 may additionally contain a mouth, eyes, and a nose that are separated from the respective ears 104. FIG. 2 illustrates an ear canal 106 portion of an ear 104 that allows sound to travel to the inner ear 108, which comprises the cochlea and vestibule.

While the ear canal 106 and inner ear 108 have a plethora of nerves and muscles that provide feeling and sensation associated with operation of the ear 104, a region 110 where the ear canal 106 changes direction from a substantially vertical orientation to a substantially horizontal orientation, which can be characterized as Noxon's ridge, is particularly dense with nerves and sensitive to physical contact. As such, conventional canine hearing protection consists of ear cups 120 or ear plugs 130 that are separated from Noxon's ridge 110, as shown in FIG. 3. However, the placement of an ear cup 120 or ear plug 130 may be unreliable and unsecure over time as the dog moves, bites, barks, or articulates muscles of the skull 102 that alter the shape of the ear canal 106.

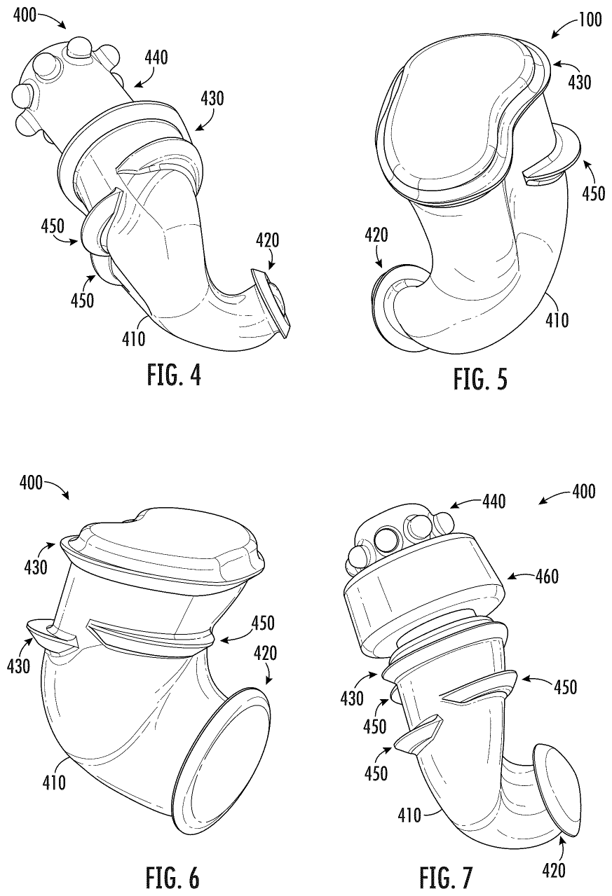

With these issues in mind, various embodiments of a canine hearing protection system structurally configure an ear plug to nest in a dog's ear canal 106 in a position proximal to Noxon's ridge to provide secure placement over time without discomfort. FIGS. 4-45 respectively illustrate assorted aspects of a canine hearing protection system that may be employed in the canine environment 100 shown in FIGS. 1-3, particularly the ear 104 and ear canal 106 of a dog.

The canine ear has unique features which that prompted the device designs shown in the assorted drawings. To understand the unique form and operation of ear devices structurally configured and operated in accordance with various embodiments, a description of the canine external ear is required. The canine external ear is distinct from the human ear in that it has a vertical and horizontal portion. The vertical canal is entirely cartilaginous and consists of the auricular cartilage which has 3 contiguous sections referred to as the scapha, concha and tubus. The length of the auricular cartilage measures 4.1 cm+/−0.9 cm. Most of this length comprises the vertical ear canal.

The scapha and concha are easily visible to the human eye and the concha includes the tragus, antitragus, anti-helix, medial crus of the helix and lateral crus of the helix. The tubus portion of the auricular cartilage lies below the cartilaginous structures that comprise the concha. The tubus forms a tube shape known as the tubus auris and it bends at its proximal end where it denotes the entry into the horizontal portion of the ear canal. The tubus auris contains a ridge known as Noxon's ridge. Noxon's ridge has a small volume cavitation medial to it that extends superiorly. This cavity enters into the bend of the ear canal thus forming the distal opening of the horizontal ear canal. The horizontal portion of the tubus auris proceeds medially toward the tympanic membrane and then the auricular cartilage encircles the annular cartilage just before it reaches the osseus ear canal and the tympanic membrane. The annular cartilage is only 1.2+/−0.2 cm in length and it fits concentrically into the tubus auris portion of the auricular cartilage.

When the pinna is retracted dorsally and caudally, the unique configuration of these articulating cartilages allows them both to pivot and effectively extend both cartilages linearly. This action moves Noxon's ridge superiorly causing the expansion and opening of the cavity medial to Noxon's ridge, straightening the bend and exposing the horizontal portion of the ear canal. Releasing the pinna reverses this and causes Noxon's ridge to move back into position and collapse this cavity into a smaller volume.

Another unique aspect of the canine ear canal distinct from humans is that it forms a cone shaped vertical ear canal. The internal diameter of the external ear opening is 5.8+/−1.5 cm. This tapers down to 0.7+/−0.2 cm at the proximal opening of the annular cartilage which is further tapered down to 0.5+/−0.1 cm at the proximal end of the annular cartilage next to the tympanic membrane. Therefore, the vertical ear canal takes the shape of a funnel or cone with its largest circumference externally toward the external auditory meatus and the smaller circumference internally toward the horizontal canal and tympanic membrane.

Additionally, the canine has 12 muscles which surround and attach to the external ear cartilage. The muscles are comprised of 4 groups that facilitate extensive movement of the canine pinna dorsally, caudally, rostrally and ventrally allowing for raising, lowering, turning and perking of the ears. When the canine shakes its head vigorously the musculature contracts and acts to stabilize the ears during this head shaking. The attachment of the deep and superficial musculature to the various cartilaginous structures that comprise the vertical ear canal and conchal bowl area. Our careful observation is that this imparts a circumferential force on the vertical ear canal and concha that results in the expulsion of an in-ear device externally from the conical shaped vertical canal, especially when combined with the headshaking forces that further tend to expel a device from the ear.

Retention of an in-ear device presents a challenge due to the conical shape of the vertical ear canal, its elasticity and compliance, lack of an osseous structure creating a rigid backstop for counterpressure and extensive musculature contracting the pinna and ear canal during vigorous head shaking forcing expulsion.

Our device design is conical in shape towards its external portion as it goes up toward the concha and then it bends into a J shape towards its internal portion going into the bend of the tubus auris. We have identified 3 distinct anatomical traits that provide a solution to the retention problem and our device is designed to take advantage of these anatomical features.

First, the demarcation between concha and tubus as defined by the various cartilaginous protuberances such as the tragus, lateral crus of the helix, etc. are a natural impediment to movement of an in-ear device. The conical shape of our device at its external portion extends radially in solid form below the concha and tragus using these protuberances as notches to hold our device in position.

Second, the bend of the tubus auris into the horizontal canal which can be manually straightened and collapses when released is advantageous for a wider opening during insertion of the device as well as constriction of that opening after the device has been placed and the tubus auris collapses. Easy insertion and stability are both achieved. Additionally, these bends are mirror images between the left and right ears and so our devices are left and right specific.

Third, the presence of Noxon's ridge and the cavitation medially creates a potential space and a properly shaped device can take advantage of that anatomy as a natural locking mechanism. Retraction of the pinna allows the “J” portion of the device to enter the cavity medial to Noxon's ridge. Upon release of the pinna, Noxon's ridge moves inferiorly into the cup of the device and the open cavity medial to Noxon's ridge collapses pinning the device inside the cavity. This action locks the “J” portion of the device into place and we define this as a “hook” or “J” lock.

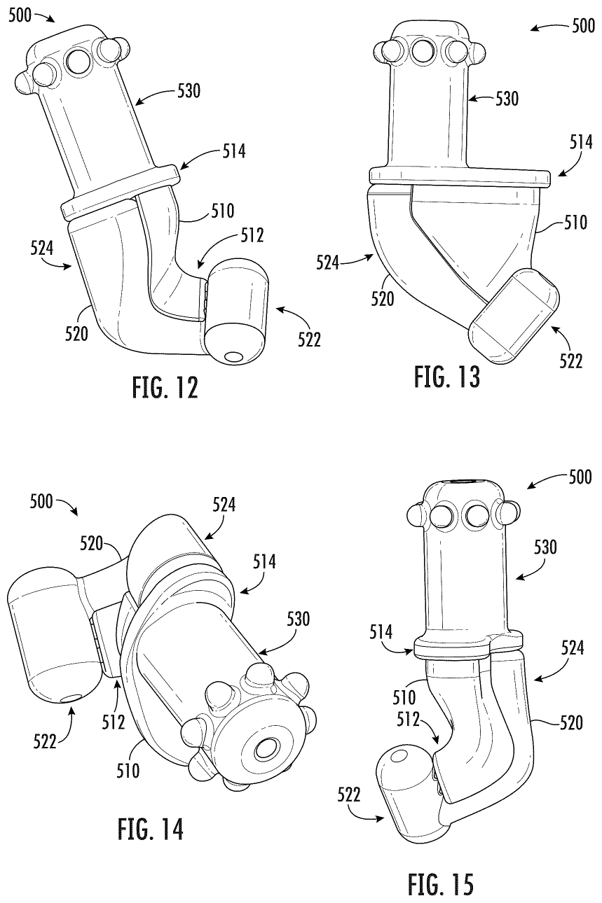

Finally, the device can also be made pneumatically, as generally shown in FIGS. 12-17. A pneumatic device will have all the advantages noted above relating to the canine ear gross anatomy. However, the pneumatic device may take advantage of the functional anatomy of the canine ear as well. As noted, the musculature surrounding the canine pinna serves to move the pinna in all directions and stabilize the pinna with vigorous head shaking, but that contraction can expel a device in the vertical canal that is not “locked” into position.

Accordingly, embodiments of a pneumatic device may be designed to specifically take advantage of this anatomical feature. A pneumatic ear device will contain air/liquid/gel that when compressed will expand a tip area positioned in the “J” region of the device. Initial compression forces will come from the surrounding tissue. After the ear device is placed in the ear canal and the pinna is released, the surrounding tissue will collapse and apply pressure on the pneumatic device's bladder near its upper external portion above Noxon's ridge. Such pressure will expand the “J” tip area as the air/liquid/gel moves from high pressure to low pressure. If the canine shakes its head or begins to bite, attack and/or move the head back and forth, the surrounding ear musculature will contract and apply additional pressure onto the pneumatic device's bladder, which further insufflating the “J” tip area. The more the muscles contract and squeeze the upper external portion of the bladder, the more the expanding tip will lock into position solidifying the retention of the pneumatic device.

From a human factors dimension, insertion of the non-pneumatic device will be made easier with left and right devices. A right-handed handler will insert a right ear device by straddling and facing in the same direction as the canine. The handler will lift the pinna dorsally and caudally with his left hand, thereby moving Noxon's ridge and exposing the horizontal canal and the device, due to its shape, will naturally fit into the cavity medial to Noxon's ridge with this technique by the handler's right hand. The same handler will insert the left ear device in a similar manner except the handler will now stand face to face with the canine and perform the same insertion technique on the left ear.

Removal of the device may be performed in the same standing positions as insertion for the right-handed handler. After retraction of the pinna, the linear configuration of the vertical and horizontal canals allow for the non-pneumatic device to slide out. Protruding ridges, which can be characterized as nurbs, allow for better grip during insertion and removal. Although the nurbs are rounded to minimize abrasion to the inside ear tissue, the ear device additionally has a closed cell foam membrane which aids in the alignment of the ear device to the middle of the ear, adds additional retention force to the device and prohibits the nurbs from contacting sensitive ear tissue without sacrificing insertion/extraction utilization of the nurbs from a human factors perspective.

An ear device employing one or more pneumatic bladders is inserted and removed in the exact same manner as the non-pneumatic device. The soft tissues and cartilaginous structures of the pinna, once collapsed around the device, will slowly create a high pressure that moves the air/liquid/gel into the “J” tip bladder area of the device. Also, once the pinna is retracted, the pressure of the surrounding soft tissue is reduced and the air/liquid/gel moves out of the “J” tip and back into the upper portion of the bladder. Left-handed handlers will stand in the same positions upon insertion and removal except they will use the right hand for pinna retraction and the left hand for device insertion and removal.

Some embodiments of an ear device place electronics and battery inside the inner part of the housing and the round cylinder positioned on the opposite side of the device from the “J” tip. It is contemplated that the lower part of the inner core can be solid (hard) or semi-solid (flexible). It is noted that the tip bladder is shown in some drawings in an over-pressured state and the ear device will apply force on tissue of a dog's ear as the ear device is fit into the ear canal.

To clarify, a pneumatic ear device will allow the tip area to increase in diameter and size dynamically by the ear musculature. The top ring below the nurbs may be constructed of foam and serve to further stabilize and center the device in the ear, create more friction coefficient for retention, and cushion the sensitive tissue in the dogs ear from being rubbed by the nurbs. Also, a hearing protection system may configure an ear device shaped for insertion into a left ear with a blue color while an ear device shaped for insertion into a right ear may have a red color. It is noted that the post that protrudes from the ear device is off-center, which may increase clearance from the ear tissue of a dog. Additionally, the off-center post may serve as a guide when inserting the ear device in a dog's ear. For instance, the post may be arranged to always point towards the back of the ear.

Some embodiments of an pneumatic ear device places a valve between the larger, more vertical, portion and the more horizontal tip portion to allow pressure to flow full open from vertical to horizontal, but slow its return from horizontal to vertical. That is, the flow of fluid in one or more bladders of an ear device may have different capabilities depending on the direction of the flow, such as towards the device tip or towards the device top. As such, the pumping action in the dog's ears may be eliminated while being more comfortable.

Two tabs on the tip portion of the ear device may fit into the hard inner core and will be either glued in place or friction force applied. These tabs serve to hold the tip part of the bladder so that it cannot be stretched away from the hard inner core when the dog tries to shake the device out, which can increase stability. It is noted that the hard inner core is shaped in such a way that it channels the pressure exerted against it from the ear muscles into the bladder so the bladder does not get moved out of position. The inner bladder is shown in some drawings inflated while the outer sleeve is not inflated.

FIGS. 4-11 respectively illustrate portions of an ear device 400 that fits in the ear canal of a dog, such as ear canal 106 of FIGS. 2 and 3, to provide optimized hearing protection, comfort, and physical security over time. The ear device 400 may provide canine hearing protection by taking advantage of the anatomy of a canine ear. The ear device 400 may utilize a unitary sleeve 410 that is composed of a material that is conducive to comfortable physical engagement with the ear canal 106 of a canine, such as silicone, thermoplastic elastomer, rubber, or another polymer.

The unitary sleeve 410 may be incorporated into a hearing protection system by surrounding a rigid core (not shown in FIGS. 4-8). Such incorporation may provide structural support for a tip portion 420 as well as a top portion 430 and one or more retention portions 450. The tip portion 420, as shown, but not required, has a protruding flange that continuously surrounds an extent of the sleeve 410 to provide enhanced physical retention once inserted into the ear canal of canine. The top portion 430 may similarly be arranged with a flange that continuously extends around the circumference of the sleeve 410 to provide enhanced physical retention once in a canine's ear.

While a sleeve 410 may utilize any number, size, type, and material of retention flanges at the tip portion 420 and top portion 430, various embodiments present one or more ridges, protrusions, or other structures that extend from the sleeve 410 that can comprise at least one retention portion 450 that further provides enhanced physical retention in an ear canal compared to a substantially smooth sleeve 410. It is noted that the various flanges and structures protruding from the sleeve 410 may be arranged with matching, or dissimilar, sizes, shapes, and lengths to accommodate a variety of different retention strategies that involve how the sleeve 410 physically engage assorted regions of a canine ear canal.

The line representation of FIG. 4 illustrates how the sleeve 410 may surround aspects of the ear device 400 while leaving a tactile portion 440 exposed. The tactile portion 440 may have any shape, size, and orientation with respect to the sleeve 410. The non-limiting example shown in FIGS. 4, 8, 10, and 11, displays how the tactile portion 440 protrudes as a cylinder with a number of separate protruding spheres to add tactile response and physical engagement enhancement compared to a smooth cylinder.

It is noted that FIGS. 5 and 6 respectively illustrate the ear device 400 without the tactile portion 440, which more clearly conveys how the unitary sleeve 410 continuously surrounds a core to form an ear plug that has a shape and size that is conducive to selective insertion, and removal, of the ear device 400 into a canine's ear canal, as shown in FIG. 9. Embodiments of the tactile portion 440 orient the cylinder off-center with respect to the geometric center of the sleeve 410. Such off-center configuration may contribute to positioning the protruding cylinder substantially in the center of the ear canal, once inserted, which reduces discomfort over time compared to if the protruding cylinder was in the center of the sleeve 410 and contacts aspects of the ear canal, once inserted.

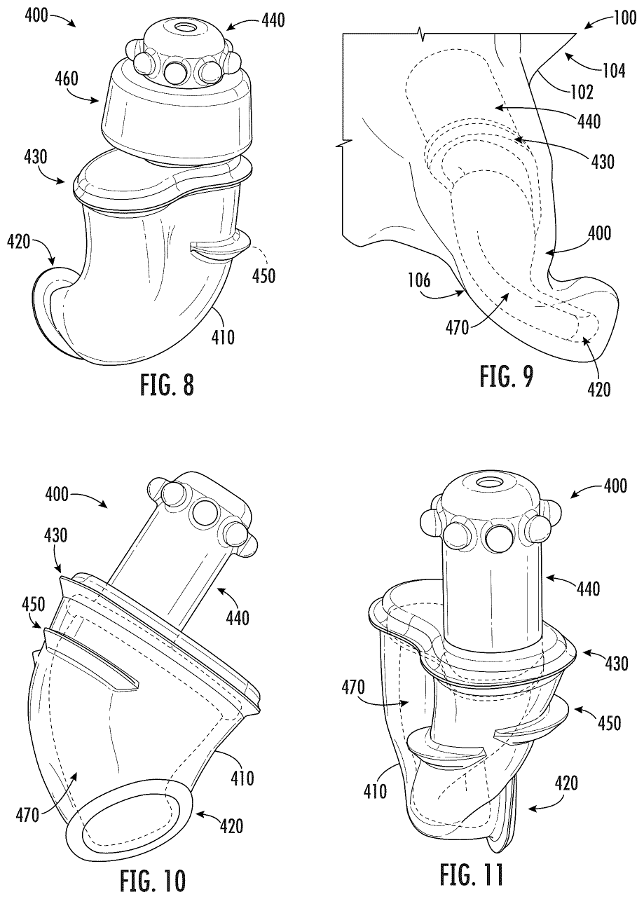

FIGS. 7 and 8 respectively illustrate an embodiment of the ear device 400 with a damping portion 460 surrounding aspects of the tactile portion 440. The damping portion 460 may be any material, size, thickness, and position relative to the tactile portion cylinder to promote comfort of the ear device 400 once inserted into an ear canal. In other words, the damping portion 460 may be structurally configured to reduce physical contact between the tactile portion 440 and the tissue of the ear canal, once inserted. In sum, the combination of off-center position of the tactile portion 440 relative to the sleeve 410, the use of a damping portion 460 provides optimized comfort without adding undue weight or complexity to the ear device 400.

FIG. 9 generally illustrates how an ear device 400 my fit within a canine's ear canal 106 with the tactile portion 440 extending beyond the ear canal 106 to allow efficient human engagement. It is noted that the ear device 400 has a rigid core 470 that may be surrounded by the sleeve 410, in some embodiments. As shown, the rigid core 470 may be structurally configured to continuously extend to a distance within the ear canal 106 that is past Noxon's ridge 110, which increases the efficiency of sound attenuation. However, contact of the rigid core 470 with Noxon's ridge 110 may produce discomfort, which is mitigated by the presence of the flexible, or semi-flexible, unitary sleeve 410.

FIGS. 10 and 11 respectively display how a rigid core 470 may be positioned within the sleeve 410, as illustrated by hollow wire cage. The ability to customize the assorted aspects of the sleeve 410 allow the comfort, and physical security, of the ear device 400 can be altered to provide efficient insertion, hearing attenuation, and removal over time. It is noted that some embodiments allow the sleeve 410 to be selectively replaced with a different sleeve, such as a different material, thickness, shape, or portions.

FIGS. 12-17 respectively illustrate portions of an example ear device 500 that may be employed in a canine hearing protection system in accordance with various embodiments. The ear device 500 has a rigid core 510 mated to a pneumatic portion 520 to provide dynamic activity in response to insertion into the ear canal 106 of a canine. Although not limiting or required, the rigid core 510 may be structurally configured with a tip portion 512 that is shaped to be proximal Noxon's ridge 110 while a top portion 514 provides a demarcation to a tactile portion 530. The pneumatic portion 520 is arranged with a bulbous portion 522 and a pressure portion 524 that operate in conjunction to provide enhanced physical retention within an ear canal 106.

FIGS. 12-15 respectively display various aspects of how the rigid core 510, pneumatic portion 520, and tactile portion 530 are structurally configured to fit within an ear canal 106 while providing dynamic operation. For instance, force applied on the pressure portion 524 by tissue of the ear canal 106 induces fluid contained within the unitary bladder of the pneumatic portion 520 into the bulbous portion 522, which increases physical retention within the ear canal 106 by expanding in size and shape.

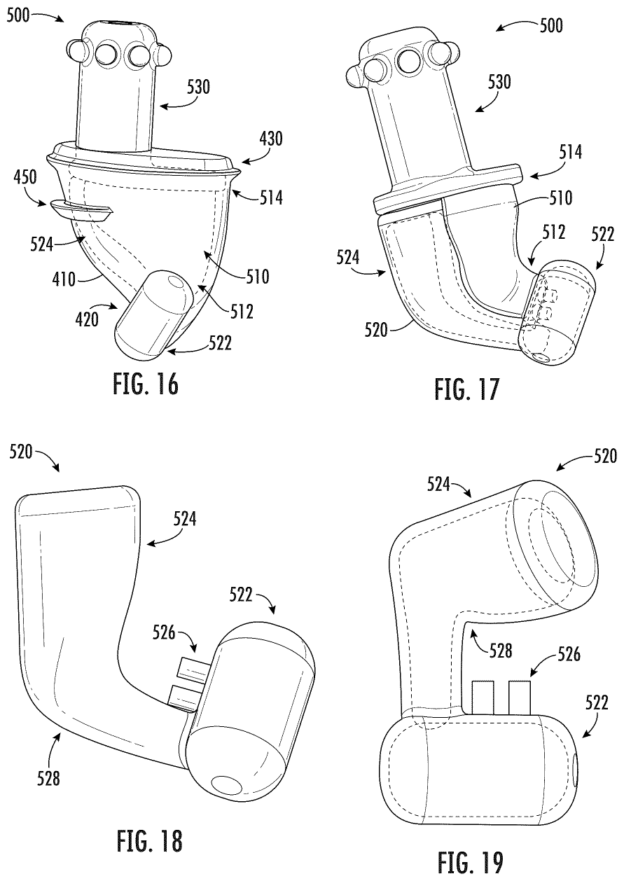

FIGS. 16 and 17 respectively convey how a sleeve 410 may surround both the rigid core 510 and pneumatic portion 520 to provide increased comfort and efficient operation. The sleeve 410, as shown by wire cage, may surround the pneumatic portion 520. However, the presence of the sleeve 410 does not prevent the pneumatic portion 520 from expanding in response to insertion into a canine's ear canal by expanding the bulbous portion 522 beyond the default shape/size shown in FIGS. 12-17.

FIGS. 18 and 19 respectively illustrate aspects of the pneumatic portion 520 of an ear device 500, and canine hearing protection system, arranged in accordance with various embodiments. FIG. 18 displays how an outside surfaces of the pneumatic portion 520 are arranged to provide reliable operation within the ear canal of a canine. FIG. 18 displays how the bladder of a pneumatic portion 520 presents a pressure portion 524 that feeds fluid, such as water, oil, or other viscous liquid, between the respective portions 522/524. For instance, the bladder may be partially filled with a liquid that is selectively forced between the pressure portion 524 and the bulbous portion 522 in response to activity of the ear canal 106, such as biting, barking, or other movement.

In FIG. 19, the pneumatic portion 520 is displayed with the outer surface shown as a hollow line representation while an inner bladder holds liquid. Some embodiments allow inner bladder to be selectively filled, or emptied, with fluid via one or more ports. The pneumatic portion 520 may have one or more attachment portions 526 that allow for efficient, and secure, physical connection of the bladder to the rigid core 510. Embodiments of the pneumatic portion 520, as shown, are arranged with a bend 528 that are structurally configured to allow fluid to flow around Noxon's ridge 110.

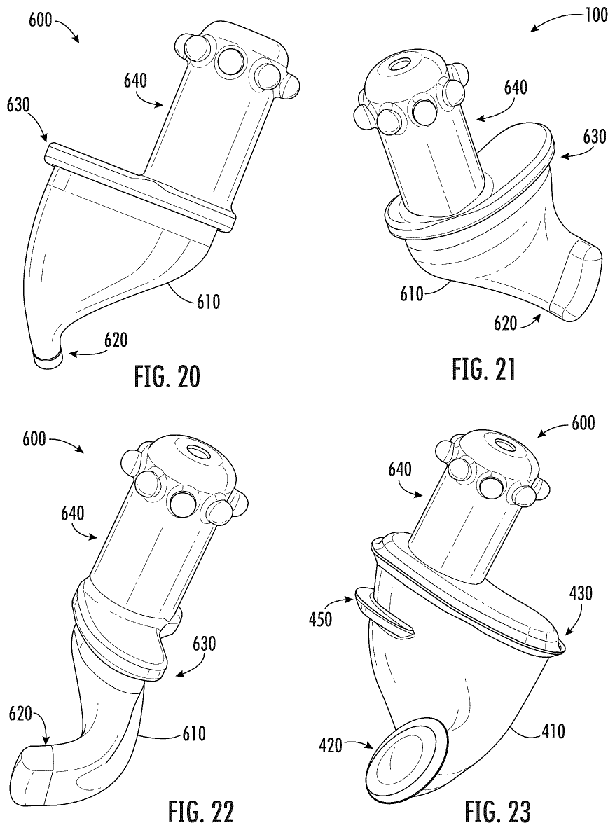

FIGS. 20-23 respectively illustrate assorted aspects of an example ear device 600 structurally configured to be employed as part of a hearing protection system. The respective drawings convey how a rigid core 610 presents a tip portion 620 that continuously extend to a top portion 630. An off-center tactile portion 640 extends from the top portion 630 to allow for manual manipulation of the ear device 600. FIG. 23 illustrates how the unitary sleeve 410 may continuously extend around the rigid core 610 to present various protrusions and flanges that aid in the physical retention of the ear device 600 in the ear canal 106 of a canine.

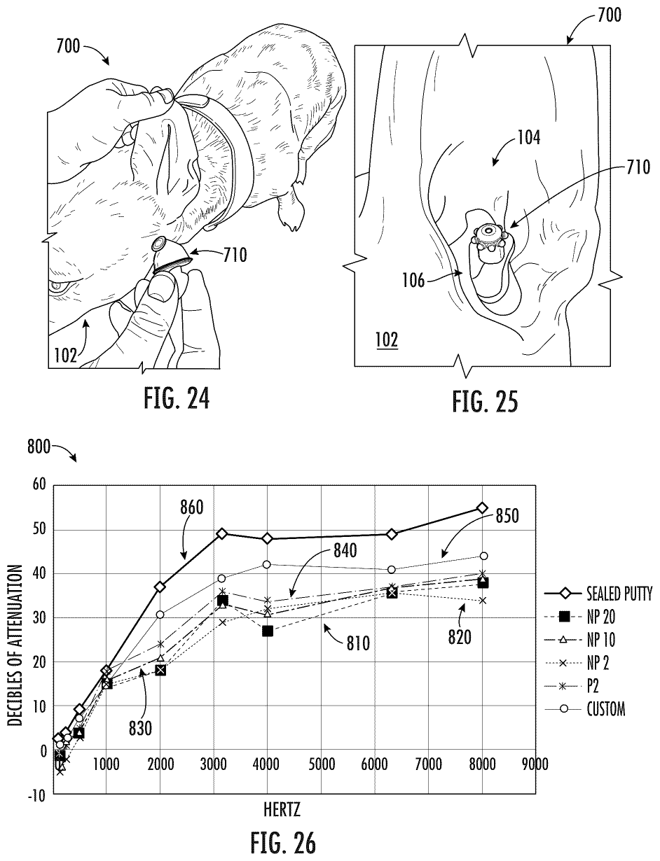

As a result of the assorted structural configurations of an ear device, a canine's ear canal may be occupied by an ear device to provide practical hearing protection. Such hearing protection may be static, as shown with ear device 400, or dynamic, as shown with the dynamic ear device 500. FIGS. 24 and 25 respectively illustrate how a human user may utilize a canine hearing protection system 700 to incorporate an ear device 710 into the ear canal 106 of a dog. The ear device 710 may be any configuration that allows secure retention in the ear canal 106, as shown in FIG. 25. It is noted that, when inserted, the ear device 710 may securely be positioned within the canine's ear canal 106 until manually removed by articulating the tactile portion of the ear device 710.

As a result of the use of a customized ear device, hearing attenuation may be provided. FIG. 26 conveys example statistical metrics associated with assorted configurations of an ear device as part of a canine hearing protection system. Line 810 corresponds with a first shore rating while line 820 corresponds with a different, lower shore rating for the sleeve 410. Line 830 corresponds with yet a different shore rating for portions of an ear device while line 840 corresponds with a pneumatic ear device and line 850 corresponds with a different ear device configuration.

Line 860 is the control line indicating maximum attenuation level. The custom device which has the best attenuation after the control. The pneumatic device has the next best attenuation levels after the custom device in the frequencies above 1000 Hz and the non-pneumatic devices have slightly lower levels of attenuation compared to the pneumatic device. Please note that all of all these tests including the control show lower attenuation below 1000 Hz with passive attenuation. When ANC is added to the devices the low frequency attenuation levels should be approximately 10-20 dB higher.

For clarity, two era devices, such as pneumatic and non-pneumatic, were tested with different shore levels of the non-pneumatic device were tested including shores 20, 10 and 2 while the pneumatic device tested was a shore 2. Additionally, a custom device was tested. A control group to determine maximal achievable attenuation was also tested using acoustical putty packed into the canal. It is noted that the various data points of FIG. 26 are exemplary and are not required, but illustrate the level of sound attenuation available with the assorted configurations of an ear device.

Through various embodiments of an ear device, the anatomy of the canine is leveraged to provide optimized hearing protection with secure physical retention. Retention is paramount and using the key aspects of canine pinna/cartilage, such as movement and gross and functional anatomy, allows for less likelihood of expulsion during head shaking or vigorous attack postures. Comfort is an additional factor and the area of Noxon's ridge can be sensitive. However, as with humans who wear in—the canal style hearing aids, sensitivity of various areas in the ear can range from nothing to mild to more severe. Habituation tends to help humans to wear ear canal style hearing aids as does duration of daily wear. It is contemplated that a majority of canines can be habituated to wear this style of device with no, or limited, discomfort.

Additional embodiments include any one of the embodiments described above, where one or more of its components, functionalities or structures is interchanged with, replaced by or augmented by one or more of the components, functionalities or structures of a different embodiment described above. It should be understood that various changes and modifications to the embodiments described herein will be apparent to those skilled in the art. Such changes and modifications can be made without departing from the spirit and scope of the present disclosure and without diminishing its intended advantages. It is therefore intended that such changes and modifications be covered by the appended claims.

Although several embodiments of the disclosure have been disclosed in the foregoing specification, it is understood by those skilled in the art that many modifications and other embodiments of the disclosure will come to mind to which the disclosure pertains, having the benefit of the teaching presented in the foregoing description and associated drawings. It is thus understood that the disclosure is not limited to the specific embodiments disclosed herein above, and that many modifications and other embodiments are intended to be included within the scope of the appended claims. Moreover, although specific terms are employed herein, as well as in the claims which follow, they are used only in a generic and descriptive sense, and not for the purposes of limiting the present disclosure, nor the claims which follow.

What is claimed is:

1. A system comprising
a rigid housing;
a sleeve surrounding the rigid housing;
an ear canal of a canine;
wherein the rigid housing is structurally configured to continuously extend beyond a Noxon's ridge of the canine;
wherein the sleeve has a tip portion and a top portion; and
wherein the tip portion comprises a flange that continuously extends around a circumference of the sleeve.

2. The system of claim 1, wherein the rigid housing is physically connected to a pneumatic portion.

3. The system of claim 2, wherein the pneumatic portion comprises a bulbous portion proximal a tip portion of the rigid housing and a pressure portion proximal a top portion of the rigid housing.

4. The system of claim 1, wherein the rigid housing comprises a tactile portion extending from the rigid housing with an off-center position relative to the sleeve.

5. The system of claim 1, wherein the tactile portion houses circuitry.

6. The system of claim 5, wherein the circuitry is configured to provide active noise cancellation.

7. The system of claim 5, wherein the tactile portion is configured to adjust sound attenuation for the canine by altering the sleeve.

8. The system of claim 1, wherein the tip portion comprises a dynamic portion, the dynamic portion comprising a hydraulic fluid.

9. The system of claim 1, wherein the housing and sleeve are collectively configured to provide passive sound attenuation to the canine.

10. The system of claim 1, wherein the rigid housing comprises a curved portion positioned proximal the tip portion and the Noxon's ridge.

11. A hearing protection system comprising:
a rigid housing;
a sleeve surrounding the rigid housing;
an ear canal of a canine;
wherein the rigid housing is structurally configured to continuously extend beyond a Noxon's ridge of the canine;
wherein the sleeve has a tip portion and a top portion; and
wherein the sleeve comprises one or more retention portions.

12. The hearing protection system of claim 11, wherein the sleeve comprises a plurality of retention portions.

13. The hearing protection system of claim 12, wherein each retention portion of the plurality of retention portions has a matching physical configuration.

14. The hearing protection system of claim 12, wherein the retention portions of the plurality of retention portions are physically separated on the sleeve.

15. The hearing protection system of claim 11, wherein a first retention portion of the one or more retention portions has a different physical configuration than a second retention portion of the one or more retention portions.

16. The hearing system of claim 11, wherein a retention portion of the one or more retention portions tapers towards the tip portion.

17. A method comprising:
placing a rigid housing into an ear canal of a canine;
attenuating sound from an inlet region of the ear canal to an ear drum region of the ear canal with a first sleeve surrounding the rigid housing;
wherein the rigid housing is structurally configured to continuously extend beyond a Noxon's ridge of the canine; and
wherein a flange of the first sleeve continuously extends around a circumference of the first sleeve to contact the ear canal beyond Noxon's ridge.

18. The method of claim 17, wherein the rigid housing a unitary component.

19. The method of claim 17, further comprising altering pressure between the inlet region and the ear drum region of the ear canal with an adjustable valve.

20. The method of claim 17, further comprising interchanging the first sleeve with a second sleeve, the first sleeve having a different physical configuration than the second sleeve.
